(19) United States
(12) Patent Application Publication
(10) Pub. No.: US 2022/0029513 A1
(43) Pub. Date: Jan. 27, 2022

(54) LINEAR VIBRATION ACTUATOR WITH ELECTROMAGNET

(71) Applicant: Mplus CO., LTD., Suwon-si (KR)

(72) Inventors: Tae Hoon Lee, Suwon-si (KR); Yeon Ho Son, Suwon-si (KR); Yong Jin Kim, Suwon-si (KR); Su Young Jung, Suwon-si (KR)

(21) Appl. No.: 17/347,936

(22) Filed: Jun. 15, 2021

(30) Foreign Application Priority Data
Jul. 21, 2020 (KR) 10-2020-0090070

(51) Int. Cl. H02K 33/02

(52) U.S. Cl. CPC H02K 33/02; B06B 1/045

(57) ABSTRACT

A linear vibration actuator includes: a casing and a bracket coupled to each other to form an internal space thereof; a centering yoke located on the center of the casing or bracket; a coil fitted to the centering yoke; a vibration yoke located in the internal space in such a manner as to be vibrated by the magnetic force generated from the centering yoke; an elastic member whose one end is fixed to the casing or bracket and the other end supports the vibration yoke to provide an elastic force; and a printed circuit board for supplying a power source to the coil.

### CROSS-REFERENCE TO RELATED APPLICATION

The present application claims the benefit of Korean Patent Application No. 10-2020-0090070 filed in the Korean Intellectual Property Office on Jul. 21, 2020, the entire content of which is incorporated herein by reference.

### BACKGROUND OF THE INVENTION

### 1. Field of the Invention

The present invention relates to a linear vibration actuator (motor), and more particularly, to a linear vibration actuator that is driven only with the attractive force created by the magnetic force generated from an electromagnet, without having a magnet used generally in a conventional linear vibration actuator.

### 2. Description of Related Art

Generally, mobile terminals like smartphones have vibration functions (haptic functions) of interfacing call incoming as well as giving a user feedback on key input, event occurrence, and application execution.

A vibration actuator with such vibration function is a device for converting an electromagnetic force into a mechanical driving force to generate vibrations, and the vibration actuator is classified largely into a flat/coin type vibration actuator and a linear type vibration actuator according to its driving type and shape.

The flat type vibration actuator generates vibrations by means of the rotation of a mass disposed therein and thus has rotational inertia remaining thereon. Accordingly, the linear vibration actuator having no rotational inertia is generally used for a device requiring a fast response speed.

On the other hand, the linear vibration actuator is designed to allow an electromagnetic force generated from a coil and a magnet and a physical elastic force generated from an elastic member to be resonant cooperatively with each other. In specific, if an alternating current power source in a specific frequency range having variable characteristics is applied to the coil to thus generate the electromagnetic force, the electromagnetic force operates mutually with the magnetic force of the magnet, so that the magnet and an oscillator like a weight coupled to the magnet become vibrated up and down, while the magnet is being supported against the elastic force of the elastic member.

FIG. 1 shows a conventional linear vibration actuator.

As shown, the conventional linear vibration actuator 1 includes a coil 10, a flexible printed circuit board 20 for supplying a power source to the coil 10, a magnet 30 vibrated by the interaction with the electromagnetic force generated from the coil 10, a weight 40 coupled to the outer peripheral surface of the magnet 30, an elastic member 50 coupled to the magnet 30 to provide an elastic force for the magnet 30, a yoke 60 for collecting a magnetic flux, a magnetic fluid 70 applied to top of the magnet 30, and a damper 80.

As mentioned above, the conventional linear vibration actuator 1 is configured to allow the electromagnetic force generated from the alternating current power source supplied to the coil 20 and the magnetic force of the magnet 30 of a vibration part to interact with each other to apply attractive and repulsive forces according to the polarity of the alternating current power source supplied to the coil 20, thereby generating strong vibrations.

However, an electronic device (for example, smartphone) using the linear vibration actuator 1 generally makes use of a battery, and so as to supply the alternating current power source to the linear vibration actuator, accordingly, converting means like an inverter for converting the direct current power source of the battery into the alternating current power source has to be needed. As a result, the manufacturing cost of the electronic device becomes high, which makes the linear vibration actuator adopted only in the electronic device like a high-end phone and thus fails to be adopted in a low-end phone.

Accordingly, there is a need for a linear vibration actuator having a new structure that is adopted in the electronic device using a battery to achieve the cost reduction through the decrease in the cost for the components and the simplification in the manufacturing processes, so that the linear vibration actuator can be widely adopted in a low-end phone as well as a high-end phone.

### SUMMARY OF THE INVENTION

Accordingly, the present invention has been made in view of the above-mentioned problems occurring in the related art, and it is an object of the present invention to provide a linear vibration actuator that is configured to have no magnet.

It is another object of the present invention to provide a linear vibration actuator that is capable of simplifying manufacturing processes and greatly reducing a manufacturing cost.

It is still another object of the present invention to provide a linear vibration actuator that is capable of being miniaturized in size.

It is yet another object of the present invention to provide a linear vibration actuator that is capable of allowing an internal space to be used more efficiently.

It is yet still another object of the present invention to provide a linear vibration actuator that is capable of directly using a direct current power source of a battery of an electronic device, without any conversion into an alternating current power source.

The technical problems to be achieved through the present invention are not limited as mentioned above, and other technical problems not mentioned herein will be obviously understood by a person of ordinary skill in the art through the following description.

To accomplish the above-mentioned objects, according to the present invention, there is provided a linear vibration actuator including: a casing and a bracket coupled to each other to form an internal space thereof; a centering yoke located on the center of the casing or bracket; a coil fitted to the centering yoke; a vibration yoke located in the internal space in such a manner as to be vibrated by the magnetic force generated from the centering yoke; an elastic member whose one end is fixed to the casing or bracket and the other end supports the vibration yoke to provide an elastic force; and a printed circuit board for supplying a power source to the coil.

According to the present invention, desirably, the linear vibration actuator further includes a weight coupled to the outer peripheral surface of the vibration yoke in such a manner as to be vibrated, together with the vibration yoke.

According to the present invention, desirably, the centering yoke is an iron core.

According to the present invention, desirably, the centering yoke has at least a hollow portion.

According to the present invention, desirably, the vibration yoke has a ‘¬’-like sectional shape.

According to the present invention, desirably, the vibration yoke includes a weight expansion member located over a bonded surface to the elastic member.

According to the present invention, desirably, either the casing or the bracket is made of a non-magnetic or weak magnetic material.

According to the present invention, desirably, the power source has a half wave-shaped waveform with dead time or offset, not an alternating current (with sine or square wave).

According to the present invention, desirably, the power source is used directly by allowing a direct current battery voltage to be switched on and off.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a sectional view showing a conventional linear vibration actuator using a magnet;

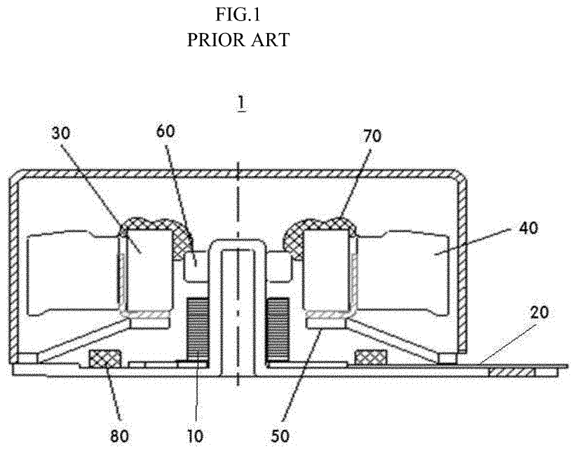

FIG. 2 is a sectional view showing a linear vibration actuator according to the present invention;

FIG. 3 shows the waveforms of the power sources supplied to the conventional linear vibration actuator and the linear vibration actuator according to the present invention;

FIG. 4 is a sectional view showing an example in which the vibration yoke of FIG. 2 is varied in size;

FIG. 5 is a sectional view showing an example in which a weight is coupled to the vibration yoke of FIG. 2; and

FIG. 6 is a sectional view showing an example in which a weight expansion member is added to the vibration yoke of FIG. 4.

### DETAILED DESCRIPTION OF THE PREFERRED EMBODIMENTS

Hereinafter, the present invention is in detail explained with reference to the attached drawings. Before the present invention is disclosed and described, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure.

In the description, when it is said that one portion is described as “includes” any component, one element further may include other components unless no specific description is suggested.

When it is said that one element is described as being “connected” or “coupled” to the other element, one element may be directly connected or coupled to the other element, but it should be understood that the two elements are “electrically connected” to each other, while placing another element therebetween. In the description, further, a signal represents the quantity of electricity like a voltage, a current, and so on, and an expression referencing a singular value additionally refers to a corresponding expression of the plural number, unless explicitly limited otherwise by the context.

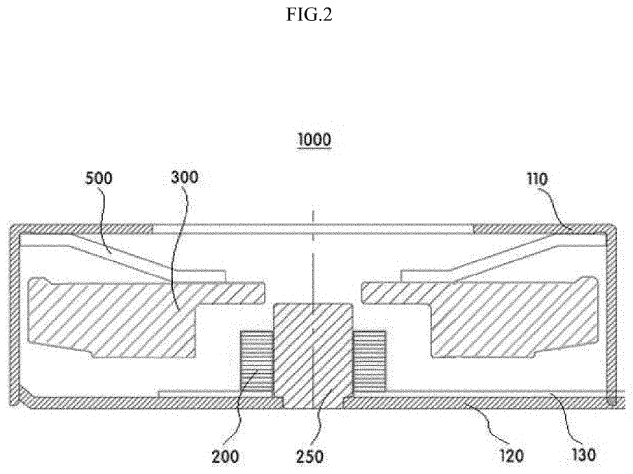

FIG. 2 is a sectional view showing a linear vibration actuator according to the present invention.

As shown in FIG. 2, a linear vibration actuator 1000 according to the present invention includes a printed circuit board 130, a coil 200, a centering yoke 250, a vibration yoke 300, and an elastic member 500, which are located in an internal space formed by a casing 110 and a bracket 120.

As shown in FIG. 2, the casing 110 and the bracket 120 are circular and they are coupled to each other to have a flat cylindrical space. However, of course, they may have various polygonal shapes such as cube and the like. The linear vibration actuator 1000 according to the present invention is configured to allow either the casing 110 or the bracket 120 to be made of a non-magnetic or weak magnetic material so as to apply a magnetic force only in one direction.

The centering yoke 250 is located on the center of the bracket 120. The centering yoke 250 may be an iron core for constituting an electromagnet.

The coil 200 is fitted to the outer peripheral surface of the centering yoke 250 fixed to the bracket 120 and receives a power source from the outside through the printed circuit board 130. The printed circuit board 130 may be a flexible PCB.

As shown in FIG. 2, the centering yoke 250 is insertedly fitted to a coupling portion formed on the center of the bracket 120, but for example, the centering yoke 250 may be formed unitarily with the bracket 120 in such a manner as to protrude from the center of the bracket 120. In this case, the protruding portion from the center of the bracket 120 may have at least a hollow portion.

Further, the centering yoke 250 may be coupled to the casing 110, not to the bracket 120, and in this case, the position of the elastic member 500 and the structure of the vibration yoke 300 may be changed according to the centering yoke 250 coupled to the casing 110.

The vibration yoke 300 is located around the coil 200 and the centering yoke 250 in such a manner as to have a ‘¬’-like sectional shape.

As shown in FIG. 2, the vibration yoke 300 has the ‘¬’-like sectional shape, but of course, the vibration yoke 300 may have various shapes, such as a shape of a vertical straight line, a tooth-shaped shape having concave and convex portions formed on the surface thereof, and so on.

The vibration yoke 300 does not produce a magnetic field by itself, unlike a magnet (permanent magnet), but the vibration yoke 300 is made of a magnetic material. If a magnetic field exists around the vibration yoke 300, accordingly, the vibration yoke 300 is attracted to the magnetic field.

The vibration yoke 300 is coupled to the elastic member 500 and thus elastically supported thereagainst.

The elastic member 500 is fixed to the casing 110 at one end thereof and coupled to the vibration yoke 300 at the other end thereof. The elastic member 500 serves to provide elasticity to the vibrations produced from the vibration yoke 300. For example, the elastic member 500 is a plate spring having a helical structure, but without being limited thereto, of course, it may be a flat elastic body.

As shown in FIG. 2, both ends of the elastic member 500 are fixed correspondingly to the casing 110 and the vibration yoke 300, but of course, it is obvious to a person of ordinary skill in the art that the elastic member 500 may be fixed to the bracket 120, not the casing 110 and to a weight, not the vibration yoke 300.

Under the above-mentioned configuration, if the power source is applied to the coil 200 to allow electric current to flow along the coil 200, the magnetic field passing through the centering yoke 250 in a longitudinal direction of the centering yoke 250 is produced from the coil 200, and in this case, the centering yoke 250 can function as the electromagnet having polarity (an north or south pole) according to the direction of the magnetic field. The direction of the magnetic field is determined by the winding direction of the coil 200.

The linear vibration actuator 1000 according to the present invention utilizes the electromagnetic force generated from the coil 200 and the centering yoke 250, without using any magnet, thereby making use of reluctance torque through which the reluctance to the vibration yoke 300 is minimized.

The vibration yoke 300 has a hole formed on the center thereof, and as the centering yoke 250 is located just under the hole of the vibration yoke 300, the vibration yoke 300 can utilize the electromagnetic force to a maximum when it is initially driven.

The vibration yoke 300 fixed to the elastic member 500 becomes vibrated up and down when it is vibrated to the maximum, thereby generating the maximum range of vibration at a resonant frequency.

In this case, the resonant frequency is determined by the following expression.

$$Frequency \text{:} f = \frac{1}{2 π} \sqrt{\frac{k}{M}} \begin{matrix}M \text{:} Mass \\ k \text{:} Spring Constant\end{matrix}$$

On the other hand, as shown in FIG. 2, the vibration yoke 300 has the hole formed on the center thereof, but if the displacement range of the vibration is sufficiently ensured even without the formation of the hole, the vibration yoke 300 may have an inverted pot-like shape whose center is closed, without having any hole.

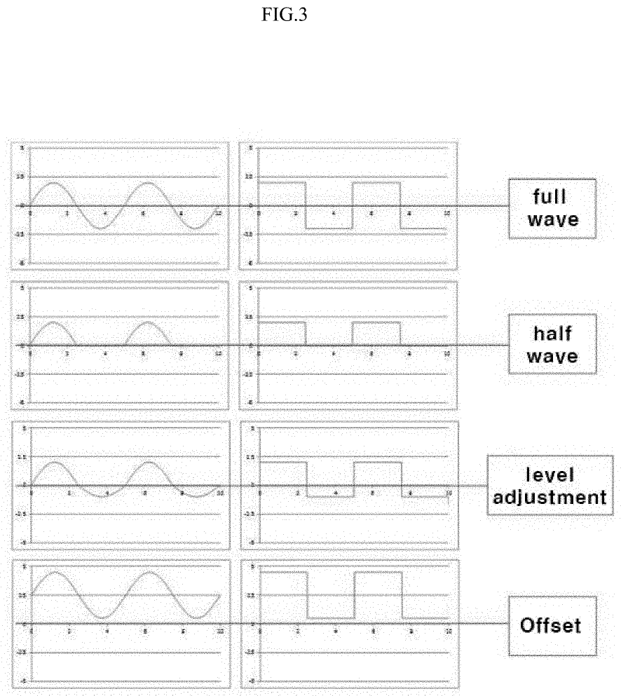

FIG. 3 shows the waveforms of the power sources supplied to the conventional linear vibration actuator and the linear vibration actuator according to the present invention.

As shown in (A) of FIG. 3, the uppermost waveform is the waveform of a full wave alternating current with a sine or square wave, which is used to drive the conventional linear vibration actuator.

The conventional linear vibration actuator becomes vibrated through the attractive and repulsive forces generated by the interaction between the electromagnetic force produced from the coil and the magnetic force of the magnet. That is, as the power source supplied to the coil is the full wave alternating current, the polarity of the power source is changed every half period, and accordingly, the direction of the magnetic field becomes changed every half period, so that the attractive and repulsive forces are alternately generated every half period between the coil and the magnet that faces only in the direction of one polarity.

Unlike the conventional linear vibration actuator, the linear vibration actuator according to the present invention does not include any magnet. According to the present invention, the vibration yoke 300 as the magnetic material is attracted irrespective of the polarity of the magnetic field, and accordingly, only the attractive force is generated between the vibration yoke 300 and the centering yoke 250.

As a result, the power source for driving the linear vibration actuator according to the present invention does not have to be a full wave alternating current.

As shown in (B) of FIG. 3, a second waveform has the half wave used to drive the linear vibration actuator according to the present invention.

According to the second waveform of the power source, the centering yoke 250 functioning as the electromagnet attracts the vibration yoke 300 in a section where a positive power source is supplied and repulses the vibration yoke 300 in a section where the power source is not supplied (in the section of dead time). Through the repetition of the attractive and repulsive forces applied to the vibration yoke 300, the vibration yoke 300 becomes vibrated.

The conventional linear vibration actuator is configured to allow the direction of the electric current applied to the coil to be varied to positive (+) and negative (−), but according to the present invention, even if the electric current is applied only to one direction, the linear vibration actuator can be driven. This means that advantageously, the linear vibration actuator according to the present invention just performs On-Off control of the supplied power source, without using any separate integrated circuit (IC).

In the case where the square wave with the half wave in the second waveform is used as the power source supplied, it is possible that a direct current (DC) battery voltage is directly used in such a manner as to be switched on and off. In this case, advantageously, there is no need to have a conversion circuit like an inverter for converting the direct current of the battery into the alternating current of the power source for driving the actuator.

As shown in (C) of FIG. 3, a third waveform is the waveform of the power source used to drive the linear vibration actuator according to the present invention, and the third waveform is adjusted in level only on one side region (negative region of FIG. 3(C)) with respect to the center axis of the full wave alternating current.

The power source having the third waveform pulls the vibration yoke 300 with a big attractive force in the positive section and pulls the vibration yoke 300 with a small attractive force in the negative section.

The third waveform supplies the power source having a relatively bigger value than the second waveform in the section of the power supply, so that the third waveform is advantageous in initial driving and allows relatively fast response time to be expected.

As shown in (D) of FIG. 3, a fourth waveform is the waveform that is formed by offsetting the entire full wave alternating current to one side direction (the positive direction in FIG. 3(D)). The size of the attractive force applied to the vibration yoke 300 is varied periodically according to the sections of the waveform.

It is obvious that the waveforms as shown in FIGS. 3A to 3D are changed in the opposite directions, under the same principles as above.

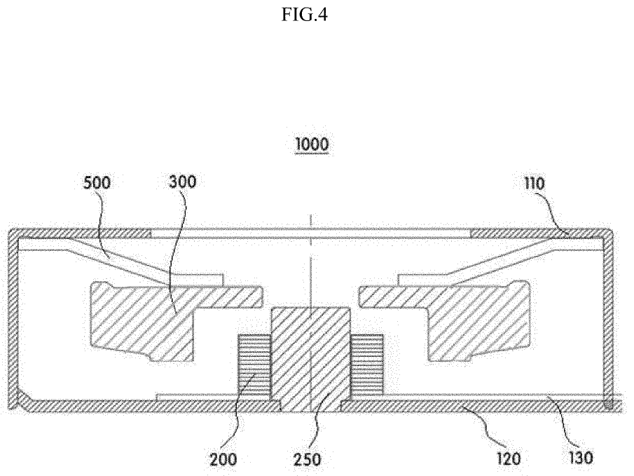

FIG. 4 is a sectional view showing an example in which the vibration yoke of FIG. 2 is varied in size.

In the linear vibration actuator according to the present invention, the size of the vibration yoke 300 may be freely determined according to a resonant frequency required, a vibration force needed, or an allowable space size.

As shown in FIG. 4, the vibration yoke 300 has a smaller size than that of FIG. 2. Of course, the size of the elastic member 500 becomes varied according to the size of the vibration yoke 300, and as a result, the entire size of the linear vibration actuator may be varied.

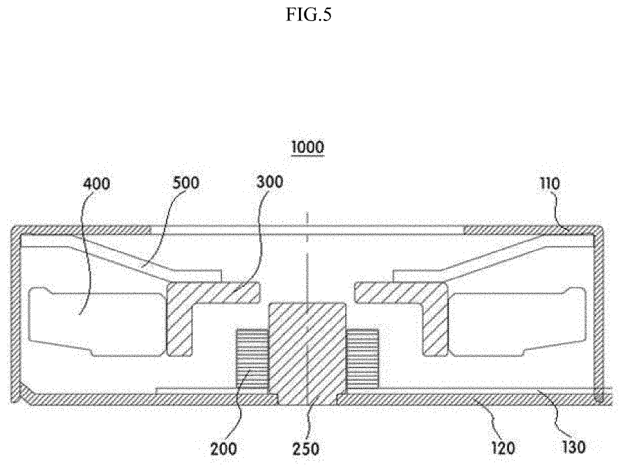

FIG. 5 is a sectional view showing an example in which a weight is coupled to the vibration yoke of FIG. 2.

If the resonant frequency or vibration force needed in the linear vibration actuator is not satisfied only with the vibration yoke 300 made of the magnetic material, as shown in FIG. 5, the size of the vibration yoke 300 is reduced and a weight 400 is additionally coupled to the outer peripheral surface of the vibration yoke 300. In this case, the weight 400 is made of a material having a relatively high specific gravity, for example, tungsten.

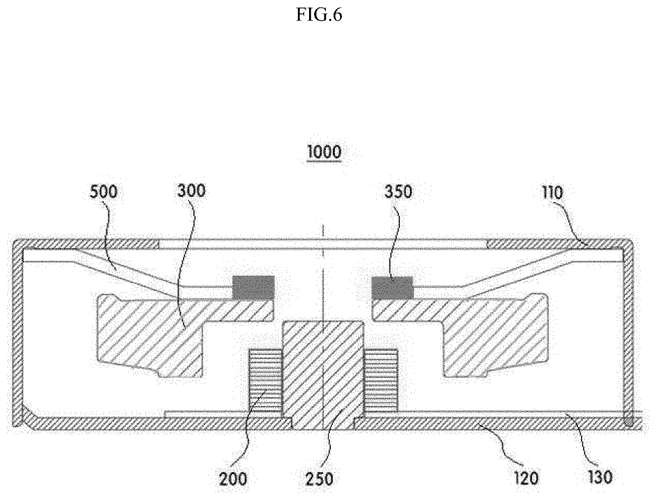

FIG. 6 is a sectional view showing an example in which a weight expansion member 360 is added to the vibration yoke 300 of FIG. 4.

According to the present invention, the inside area of the elastic member 500 on top of the boundary surface where the vibration yoke 300 and the elastic member 500 are bonded to each other is an empty space that is not available.

If there is a need to add a given weight so as to satisfy the resonant frequency or vibration force needed, accordingly, the inside area of the elastic member 500 on top of the vibration yoke 300 is utilized to locate the weight expansion member 360 thereon, thereby enhancing the efficiency in space utilization.

The weight expansion member 360 is made of a different material from the vibration yoke 300 and separately machined and bonded to the inside area of the elastic member 500, and otherwise, the weight expansion member 360 may be formed unitarily with the vibration yoke 300.

The linear vibration actuator according to the present invention is configured to suggest a new structure using the principle of the electromagnet, without using any magnet, while having the similar characteristics to the conventional linear vibration actuator, thereby lowering the cost for the components and simplifying the manufacturing processes when compared to the conventional linear vibration actuator to thus enable the manufacturing cost to be greatly reduced.

Accordingly, the manufacturing cost of the linear vibration actuator according to the present invention can be greatly lowered when compared to the conventional linear vibration actuator, thereby providing the haptic function even for the low-end phone.

As described above, the linear vibration actuator according to the present invention does not have any magnet, thereby simplifying the manufacturing processes and greatly lowering the manufacturing cost.

In addition, the linear vibration actuator according to the present invention has no magnet so that the magnetic force generated from the magnet does not exist, thereby reducing the internal space thereof, and allows the vibration yoke to have only the downward attractive force to the electromagnet in such a manner as to allow only the elastic force generated from the elastic member to be applied to the upward displacement portion thereof, thereby being more miniaturized in size than the linear vibration actuator using the magnet.

Further, the linear vibration actuator according to the present invention allows the internal space to be used more efficiently.

Also, the linear vibration actuator according to the present invention directly uses the direct current power source of the battery of the electronic device using the linear vibration actuator, without any conversion into the alternating current power source.

The effectiveness of the invention is not limited as mentioned above, and it should be understood to a person of ordinary skill in the art that the effectiveness of the invention may include another effectiveness as not mentioned above from the detailed description of the present invention.

The embodiment of the present invention has been in detail described so that it may be carried out easily by those having ordinary skill in the art, and therefore, this does not limit the idea and technical scope of the invention.

While the present invention has been described with reference to the particular illustrative embodiments, it is not to be restricted by the embodiments but only by the appended claims. It is to be appreciated that a person of ordinary skill in the art can change or modify the embodiments without departing from the scope and spirit of the present invention.

What is claimed is:

1. A linear vibration actuator comprising:
a casing and a bracket coupled to each other to form an internal space thereof;
a centering yoke located on the center of the casing or bracket;
a coil fitted to the centering yoke;
a vibration yoke located in the internal space in such a manner as to be vibrated by the magnetic force generated from the centering yoke;
an elastic member whose one end is fixed to the casing or bracket and the other end supports the vibration yoke to provide an elastic force; and
a printed circuit board for supplying a power source to the coil.

2. The linear vibration actuator according to claim 1, further comprising a weight coupled to the outer peripheral surface of the vibration yoke in such a manner as to be vibrated, together with the vibration yoke.

3. The linear vibration actuator according to claim 1, wherein the centering yoke is an iron core.

4. The linear vibration actuator according to claim 1, wherein the centering yoke has at least a hollow portion.

5. The linear vibration actuator according to claim 1, wherein the vibration yoke has a ‘¬’-like sectional shape.

6. The linear vibration actuator according to claim 1, wherein the vibration yoke comprises a weight expansion member located over a bonded surface to the elastic member.

7. The linear vibration actuator according to claim 1, wherein either the casing or the bracket is made of a non-magnetic or weak magnetic material.

8. The linear vibration actuator according to claim 1, wherein the power source has a half wave-shaped waveform.

9. The linear vibration actuator according to claim 1, wherein the power source has the waveform formed by offsetting a full wave alternating current to one side direction.

10. The linear vibration actuator according to claim 1, wherein the power source has the waveform formed by reducing the amplitudes on a negative region of a full wave alternating current.

11. The linear vibration actuator according to claim 1, wherein the power source is used directly by allowing a direct current battery voltage to be switched on and off.
